(19) United States
(12) Patent Application Publication
(10) Pub. No.: US 2025/0269754 A1
(43) Pub. Date: Aug. 28, 2025

(54) FLEET-BASED MERCHANT DISCOUNT SYSTEM AND METHOD THEREFOR

(71) Applicant: Visa International Service Association, San Francisco, CA (US)

(72) Inventors: Ghaith Mohammed Hararah, Fremont, CA (US); Adi Mistry, San Francisco, CA (US); William Parker Patton, JR., Orinda, CA (US); Xuemei Zhang, Mountain View, CA (US); Kate Kennedy, San Francisco, CA (US); Victor Kenneth Miller, Davis, CA (US); Arindam Halder, Highlands Ranch, CO (US)

(73) Assignee: Visa International Service Association, San Francisco, CA (US)

(21) Appl. No.: 18/589,366

(22) Filed: Feb. 27, 2024

(51) Int. Cl. B60L 53/66; G06Q 30/0226

(52) U.S. Cl. CPC B60L 53/665; G06Q 30/0226

(57) ABSTRACT

In some embodiments, a computer-implemented method, includes receiving, at a fleet-based merchant discount portal of a payment processing network, an advice message from an acquirer, the advice message being associated with a fleet-based vehicle energy purchase initiated at an access device of a merchant; performing a fleet-based merchant discount qualification assessment of the advice message at the fleet-based merchant discount portal to determine whether to apply a fleet-based merchant discount to the fleet-based vehicle energy purchase; and when the fleet-based merchant discount qualification assessment yields that the fleet-based merchant discount is warranted, utilizing a fleet-based merchant discount advice message to perform the fleet-based merchant discount of the fleet-based vehicle energy purchase, the fleet-based merchant discount advice message being created by adding fleet-based merchant discount fields to the advice message to discount the fleet-based vehicle energy purchase.

### BACKGROUND

The background description provided herein is for the purpose of generally presenting the context of the disclosure. Work of the presently named inventor(s), to the extent it is described in this background section, as well as aspects of the description that may not otherwise qualify as prior art at the time of filing, are neither expressly nor impliedly admitted as prior art against the present disclosure.

Fleet industry energy, such as, for example, gasoline, diesel, and electricity, customers in a fuel ecosystem have long received discounts from gasoline merchants for fuel purchases. In the fuel ecosystem, the ability of gasoline merchants to negotiate and implement discounts with fleet industry gasoline customers is a major component in generating and maximizing revenue for the gasoline merchants. Hence, gasoline merchants need an effective way to manage and implement gasoline discounts to entice fleet trucking companies to provide business to the gasoline merchants. Thus, a need exists to provide payment transaction systems that enhance and support discounts provided to fleet industry gasoline customers to increase business for gasoline merchants.

### BRIEF DESCRIPTION OF THE DRAWINGS

FIG. 1 illustrates a block diagram of a payment transaction system in accordance with some embodiments.

FIG. 2 illustrates a block diagram of a payment processing network computer of payment transaction system of FIG. 1 in accordance with some embodiments.

FIG. 3 illustrates a block diagram of a fleet-based merchant discount portal utilized in the payment processing network computer of FIG. 2 in accordance with some embodiments.

FIG. 4 is a flow diagram illustrating a fleet-based merchant discount application method in accordance with some embodiments.

### DETAILED DESCRIPTION

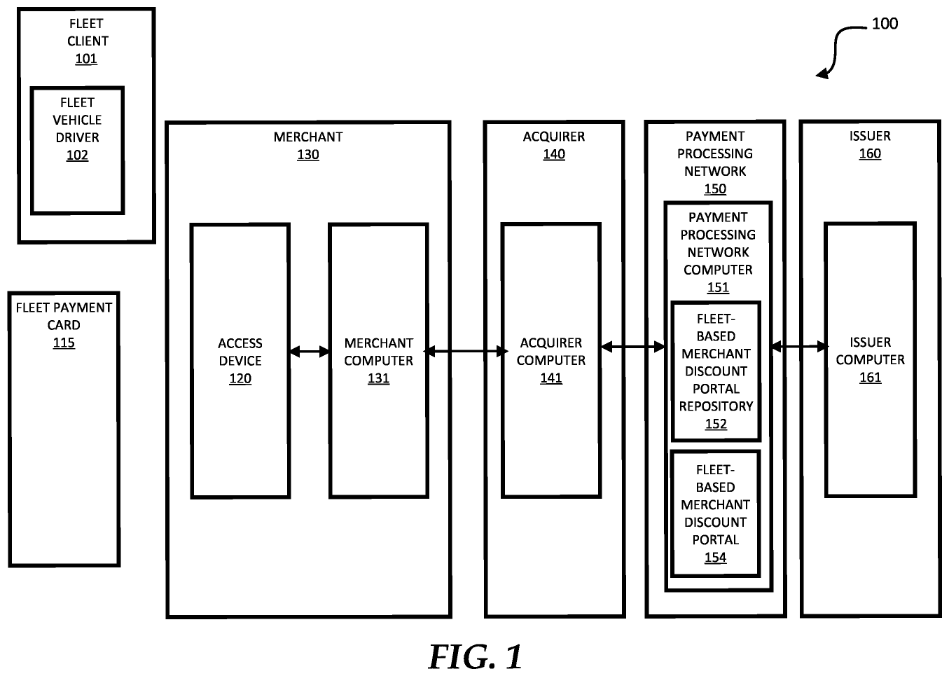

FIG. 1 illustrates a payment transaction system 100 in accordance with some embodiments. In some embodiments, the payment transaction system 100 is a payment transaction system configured to utilize a fleet-based merchant discount portal 154 in payment processing network 150 to provide a fleet-based merchant discount to a fleet-based vehicle energy purchase initiated by a fleet client 101 (e.g., fleet vehicle driver 102) at merchant 130. In some embodiments, a fleet-based vehicle energy purchase is a purchase of vehicle energy (e.g., fuel purchase and/or electricity purchase) made by fleet vehicle driver 102 at merchant 130. In some embodiments, a fleet-based merchant discount is a monetary discount applied to an authorized fleet-based vehicle energy payment transaction (e.g., authorized fleet-based vehicle energy purchase made by fleet client 101 (or fleet vehicle driver 102) by fleet-based merchant discount portal 154 on behalf of merchant 130. In some embodiments, the fleet-based merchant discount portal 154 is executable code and/or hardware configured to operate as a portal for merchant 130 in payment processing network 150. In some embodiments, fleet-based merchant discount portal repository 152 is a repository of discount information utilized by fleet-based merchant discount portal 154 to perform fleet-based merchant discount portal operations, such as, for example, reviewing and assessing a payment transaction to apply a fleet-based merchant discount. In some embodiments, the fleet-based merchant discount portal 154 is configured to allow merchants, such as, for example, merchant 130, to utilize a fleet-based merchant discount program at the fleet-based merchant discount portal 154 to provide the fleet-based merchant discount to the fleet-based vehicle energy purchase made by fleet vehicle driver 102 at merchant 130, described further in detail herein.

In some embodiments, payment transaction system 100 includes a merchant 130, an acquirer 140, a payment processing network 150, and an issuer 160. In some embodiments, merchant 130 includes an access device 120 and a merchant computer 131. In some embodiments, acquirer 140 includes an acquirer computer 141. In some embodiments, payment processing network 150 includes a payment processing network computer 151. In some embodiments, payment processing network computer 151 includes fleet-based merchant discount portal repository 152 and fleet-based merchant discount portal 154. In some embodiments, issuer 160 includes an issuer computer 161. In some embodiments, payment transaction system 100 is an open-loop payment transaction system with open-loop payment functionality, e.g., where payment transactions are open loop because the payment transactions may by initiated with an access device (e.g., access device 120) that is configured to process payment transactions for payment processing network 150.

In some embodiments, an “access device”, such as, for example, access device 120 of merchant 130, may be any suitable device for communicating with merchant computer 131 and/or acquirer computer 141 and payment processing network computer 151, and for interacting with a payment device, payment card (e.g., fleet payment card 115), a user computer apparatus, and/or a user mobile device. In some embodiments, an access device may generally be located in any suitable location, such as at the location of merchant 130. In some embodiments, an access device may be in any suitable form. Some examples of access devices include POS devices, cellular phones, PDAs, personal computers (PCs), tablet PCs, hand-held specialized readers, set-top boxes, electronic cash registers (ECRs), automated teller machines (ATMs), virtual cash registers (VCRs), kiosks, security systems, access systems, Websites, and the like. In some embodiments, an access device may use any suitable contact or contactless mode of operation to send or receive data from, or associated with, a payment device, payment card (e.g., fleet payment card 115) and/or a mobile device. In some embodiments, where an access device may comprise a POS terminal, any suitable POS terminal may be used and may include a reader, a processor, and a computer-readable medium. In some embodiments, a reader may include any suitable contact or contactless mode of operation. For example, exemplary card readers can include radio frequency (RF) antennas, optical scanners, bar code readers, or magnetic stripe readers to interact with a payment device, payment card, and/or mobile device. In the examples provided herein, an access device and merchant computer may be referred to as separate system components. It should be appreciated, however, that the access device and merchant computer may be a single component, for example, one merchant communication device or POS device.

In some embodiments, a “merchant”, such as, for example, merchant 130, is an entity that engages in transactions involving the sale of goods and/or services, such as, for example, fleet-based vehicle energy, to customers and clients (e.g., fleet client 101) of merchant 130. In some embodiments, merchant computer 131 is a computer utilized by merchant 130 that is configured to communicate and perform merchant sale operations in payment transaction system 100. For example, in some embodiments, the merchant computer 131 is a computer that, in addition to performing traditional merchant operations for merchant 130, is involved in the sale of fleet-based vehicle energy to fleet client 101 illustrated in payment transaction system 100.

In some embodiments, an “acquirer”, e.g., acquirer 140, is a business entity that, in addition to performing traditional acquirer operations in payment transaction system 100, is configured to perform acquirer related fleet-based merchant discount payment transaction operations for payment transaction system 100. In some embodiments, acquirer 140 is typically a business entity (e.g., a commercial bank) that has a business relationship with a merchant (e.g., merchant 130) or other entity. Some entities may perform both issuer and acquirer functions. Some embodiments may encompass such single entity issuer-acquirers. Each of the entities may comprise one or more computer apparatuses to enable communications, or to perform one or more of the functions described herein. In some embodiments, acquirer computer 141 is a computer that, in addition to performing traditional acquirer computer operations in payment transaction system 100, is configured to perform acquirer computer related fleet-based merchant discount payment transaction operations in payment transaction system 100.

In some embodiments, a payment processing network, e.g., payment processing network 150, is a payment processing entity that, in addition to being configured to perform traditional payment processing network operations, is configured to perform fleet-based merchant discount portal operations in payment transaction system 100. In some embodiments, payment processing network 150 includes a payment processing network computer 151 that, in addition to being configured to perform traditional payment processing network computer operations, may be configured to perform fleet-based merchant discount portal operations in payment transaction system 100. In some embodiments, the payment processing network may include data processing subsystems, networks, and operations used to support and deliver fleet-based merchant discount portal operations, certificate authority services, authorization services, exception file services, transaction scoring services, and clearing and settlement services. An exemplary payment processing network may include VisaNet™. Payment processing networks such as, for example, VisaNet™, are able to process fleet-based vehicle energy payment transactions, fleet-based payment card transactions, credit card transactions, debit card transactions, and other types of commercial transactions. VisaNet™, in particular, includes a VIP system (Visa Integrated Payments system) which may process authorization requests and a Base II system which may perform, for example, clearing and settlement services.

In some embodiments, an “issuer”, e.g., issuer 160, may typically refer to a business entity (e.g., a bank) that maintains financial accounts for merchant 130, fleet vehicle driver 102, and/or fleet client 101 in payment transaction system 100 and often issues a credit card or debit card (e.g., fleet payment card 115) to, for example, fleet vehicle driver 102 and/or fleet client 101. In some embodiments, issuer computer 161 is a computer that, in addition to performing traditional issuer computer operations in payment transaction system 100, is configured to perform issuer computer related fleet-based payment transaction operations in payment transaction system 100.

In some embodiments, a “mobile device” (not illustrated in FIG. 1) may be an electronic device that may be transported and operated by a user, which may also provide remote communication capabilities to a network. Examples of remote communication capabilities include using a mobile phone (wireless) network, wireless data network (e.g., 3G, 4G or similar networks), Wi-Fi, Wi-Max, or any other communication medium that may provide access to a network such as the Internet or a private network. Examples of mobile devices include mobile phones (e.g., cellular phones), PDAs, tablet computers, net books, laptop computers, personal music players, hand-held specialized readers, etc. In some embodiments, mobile device may include any suitable hardware and software for performing such functions, and may also include multiple devices or components (e.g., when a device has remote access to a network by tethering to another device—i.e., using the other device as a modem—both devices taken together may be considered a single mobile device). In some embodiments, a mobile device may also include a verification token in the form of, for instance, a secured hardware or software component within the mobile device and/or one or more external components that may be coupled to the mobile device. In some embodiments, instead of a fleet payment card 115 being utilized to make a fleet-based vehicle energy purchase, the mobile device may be utilized to make a fleet-based vehicle energy purchase in payment transaction system 100.

In some embodiments, as stated previously, fleet-based merchant discount portal 154 is configured to operate as a portal in payment processing network 150 that implements a fleet-based merchant discount program in payment transaction system 100. In some embodiments, a fleet-based merchant discount program is a discount program offered, managed, and implemented by fleet-based merchant discount portal 154 of payment processing network 150 in payment transaction system 100. In some embodiments, the fleet-based merchant discount program is configured to allow the fleet-based merchant discount portal 154 to provide the fleet-based merchant discount to fleet client 101 of a fleet-based merchant discount program member. In some embodiments, a fleet-based merchant discount program member is a member of a fleet-based merchant discount program that is managed by fleet-based merchant discount portal 154. In some embodiments, a fleet client 101 is a corporation or other entity that operates a fleet of vehicles that utilize merchant 130 to purchase fleet-based vehicle energy. In some embodiments, fleet client 101 may be enrolled in a fleet-based merchant discount plan, vis-a-vis merchant 130, to receive a fleet-based merchant discount offered by merchant 130 via fleet-based merchant discount portal 154 of payment processing network 150. In some embodiments, fleet vehicle driver 102 is a driver or operator of a fleet vehicle for fleet client 101 that utilizes a fleet payment card 115 or the like to make a fleet-based vehicle energy purchase at merchant 130. In some embodiments, fleet payment card 115 is a payment card utilized by fleet vehicle driver 102 to purchase fleet-based vehicle energy at an access device 120 of merchant 130. In some embodiments, authorized fleet clients (e.g., fleet clients associated with authorized fleet-based vehicle energy payment transactions) of fleet-discount merchant program members may receive a fleet-based merchant discount on goods and/or services offered as part of a fleet-based merchant discount program.

In some embodiments, a fleet-based merchant discount plan is a discount plan utilized by fleet-based merchant discount portal 154 (illustrated by way of example in FIG. 1-FIG. 3) to implement a fleet-based merchant discount for merchant 130. In some embodiments, the fleet-based merchant discount plan includes fleet-based merchant discount information and other operational details related to the fleet-based merchant discount that allow fleet-based merchant discount portal 154 to be utilized to implement a fleet-based merchant discount during a fleet-based vehicle energy payment transaction. In some embodiments, a fleet-based vehicle energy payment transaction is a payment transaction for a fleet-based vehicle energy purchase made by a fleet vehicle driver 102 of a fleet client 101 in payment transaction system 100. In some embodiments, the fleet-based vehicle energy payment transaction may be initiated utilizing a fleet payment card 115 in payment transaction system 100 for a purchase of fleet-based vehicle energy, described further in detail herein. In some embodiments, the fleet-based vehicle energy payment transaction may involve a single energy code transaction (e.g., single fuel code transaction) or a multiple energy code transaction (e.g., multiple fuel code transaction). In some embodiments, a single energy code transaction involves the vehicle energy purchase of only a single type of energy, whereas a multiple energy code transaction involves the purchase of multiple types of vehicle energy.

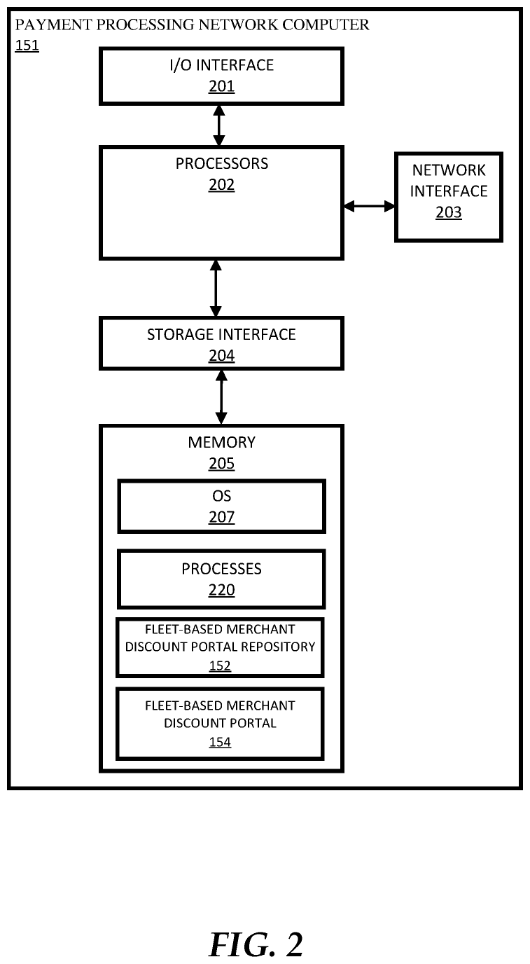

In some embodiments, utilization of fleet-based merchant discount portal 154 in payment processing network 150 allows merchant 130 (enrolled in a fleet-based merchant discount program at the fleet-based merchant discount portal 154) to provide the fleet-based merchant discount to the fleet-based vehicle energy purchase made by fleet vehicle driver 102 at merchant 130. In some embodiments, by utilizing the fleet-based merchant discount portal 154, merchant 130 is able to increase business by allowing the fleet-based merchant discount portal 154 of payment processing network 150 to calculate and apply a fleet-based merchant discount based on, for example, an agreed upon fleet-based merchant discount plan. Fleet-based merchant discount portal 154 is described further in detail herein with reference to FIG. 2-FIG. 4.

FIG. 2 illustrates a block diagram of payment processing network computer 151 of FIG. 1 in accordance with some embodiments. In some embodiments, payment processing network computer 151 includes an input/output (IO) interface 201, processor/s 202, a storage interface 204, a network interface 203, and memory 205. In some embodiments, payment processing network computer 151 may be, for example, a system, such as a computer system utilized to implement embodiments described herein. In some embodiments, memory 205 may include an operating system (OS) 207, processes 220, and a fleet-based merchant discount portal 154.

In some embodiments, processors 202 may comprise at least one data processor for executing program components for dynamic resource allocation at run time. The processors 202 may include specialized processing units such as integrated system (bus) controllers, memory management control units, floating point units, graphics processing units, digital signal processing units, etc. In some embodiments, the processors 202 may be disposed in communication with one or more input/output (I/O) devices (not shown) via an I/O interface 201. The I/O interface 201 may employ communication protocols/methods such as, without limitation, audio, analog, digital, monoaural, RCA, stereo, IEEE-1394, serial bus, universal serial bus (USB), infrared, PS/2, BNC, coaxial, component, composite, digital visual interface (DVI), high-definition multimedia interface (HDMi), RF antennas, S-Video, VGA, IEEE 802.1 n/b/g/n/x, Bluetooth®, cellular (e.g., code-division multiple access (CDMA), high-speed packet access (HSPA+), global system for mobile communications (GSM), long-term evolution (LTE), WiMax®, or the like), etc.

In some embodiments, using the I/O interface 201, the payment processing network computer 151 may communicate with one or more I/O devices. For example, an input device (not shown) may be an antenna, keyboard, mouse, joystick, (infrared) remote control, camera, card reader, fax machine, dongle, biometric reader, microphone, touch screen, touchpad, trackball, stylus, scanner, storage device, transceiver, video device/source, etc. An output device (not shown) may be a printer, fax machine, video display (e.g., cathode ray tube (CRT), liquid crystal display (LCD), light-emitting diode (LED), plasma, Plasma display panel (PDP), Organic light-emitting diode display (OLED) or the like), audio speaker, etc.

In some embodiments, the processors 202 may be disposed in communication with a communication network or other type of network via a network interface 203. The network interface 203 may communicate with the communication network. In some embodiments, network interface 203 may employ connection protocols including, without limitation, direct connect, Ethernet (e.g., twisted pair 10/100/1000 Base T), transmission control protocol/Internet protocol (TCP/IP), token ring, IEEE 802.11a/b/g/n/x, etc. The communication network may include, without limitation, a direct interconnection, e-commerce network, a peer to peer (P2P) network, local area network (LAN), wide area network (WAN), wireless network (e.g., using Wireless Application Protocol), the internet, Wi-Fi®, etc. Using the network interface 203 and the communication network, the payment processing network computer 151 may communicate with the one or more service operators, service machines, and/or destination machines.

In some non-limiting embodiments or aspects, the processors 202 may be disposed in communication with a memory 205 (e.g., RAM, ROM, etc.) via a storage interface 204. In some embodiments, the storage interface 204 may connect to memory 205 including, without limitation, memory drives, removable disc drives, etc., employing connection protocols such as serial advanced technology attachment (SATA), Integrated Drive Electronics (IDE), IEEE-1394, Universal Serial Bus (USB), fiber channel, Small Computer Systems interface (SCSI), etc. The memory drives may further include a drum, magnetic disc drive, magneto-optical drive, optical drive, Redundant Array of Independent Discs (RAID), solid-state memory devices, solid-state drives, etc.

In some embodiments, the memory 205 may store a collection of program or database components, including, without limitation, a user interface, an operating system 207, a web server, etc. In some non-limiting embodiments or aspects, the payment processing network computer 151 may store user/application data, such as the data, variables, records, etc. as described in this disclosure. Such databases may be implemented as fault-tolerant, relational, scalable, secure databases such as Oracle or Sybase.

In some embodiments, the operating system 207 may facilitate resource management and operation of the payment processing network computer 151. Examples of operating systems include, without limitation, APPLE® MACINTOSH® OS X®, UNIX®, UNIX-like system distributions (E.G., BERKELEY SOFTWARE DISTRIBUTION® (BSD), FREEBSD®, NETBSD®, OPENBSD, etc.), LINUX® DISTRIBUTIONS (E.G., RED HAT®, UBUNTU®, KUBUNTU®, etc.), IBM® OS/2®, MICROSOFT® WINDOWS® (XP®, VISTA®/7/8, 10 etc.), APPLE® OS®, GOOGLE™ ANDROID™, BLACKBERRY® OS, or the like.

In some non-limiting embodiments or aspects, the payment processing network computer 151 may implement a web browser (not shown in the figures) stored program component. The web browser (not shown in the figures) may be a hypertext viewing application, such as MICROSOFT® INTERNET EXPLORER®, GOOGLE™ CHROME™, MOZILLA® FIREFOX®, APPLE® SAFARI®, etc. Secure web browsing may be provided using Secure Hypertext Transport Protocol (HTTPS), Secure Sockets Layer (SSL), Transport Layer Security (TLS), etc. Web browsers may utilize facilities such as AJAX, DHTML, ADOBE® FLASH®, JAVASCRIPT®, JAVA®, Application Programming Interfaces (APIs), etc.

Furthermore, one or more computer-readable storage media may be utilized in implementing embodiments consistent with the present disclosure. In some embodiments, a computer-readable storage medium refers to any type of physical memory on which information or data readable by a processor may be stored. Thus, a computer-readable storage medium may store instructions for execution by one or more processors, including instructions for causing the processor(s) to perform steps or stages consistent with the embodiments described herein. The term “computer-readable medium” should be understood to include tangible items and exclude carrier waves and transient signals, e.g., non-transitory. Examples include Random Access Memory (RAM), Read-Only Memory (ROM), volatile memory, non-volatile memory, hard drives, Compact Disc (CD) ROMs, Digital Video Disc (DVDs), flash drives, disks, and any other known physical storage media.

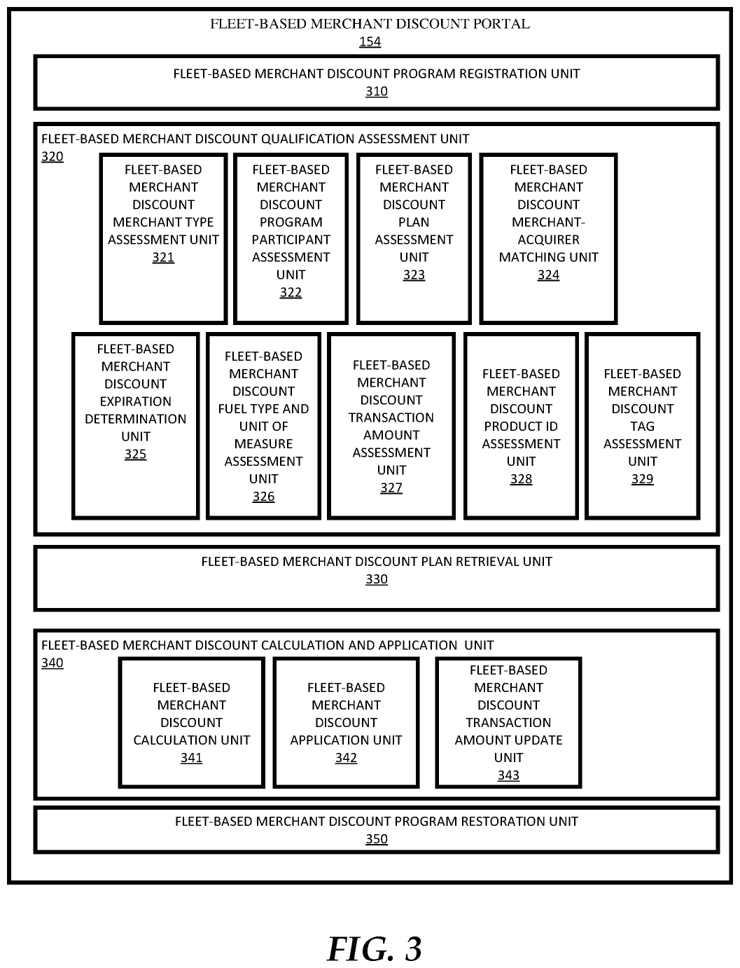

FIG. 3 is a block diagram illustrating fleet-based merchant discount portal 154 in accordance with some embodiments. In some embodiments, as stated previously, the fleet-based merchant discount portal 154 is executable code configured to operate as a fleet-based merchant discount program portal in payment processing network 150 of payment transaction system 100. In some embodiments, fleet-based merchant discount portal 154 is configured to allow merchant 130 to utilize a fleet-based merchant discount program managed by the fleet-based merchant discount portal 154 to provide a fleet-based merchant discount to a fleet client 101 for a fleet-based vehicle energy purchase at merchant 130. In some embodiments, use of the fleet-based merchant discount portal 154 in payment processing network 150 serves as an improvement over other computer systems in traditional payment transaction systems in that, for example, use of the fleet-based merchant discount portal 154 reduces the amount of processing and hardware required at multiple locations across payment transaction system 100, thereby providing increased reliability and improved efficiency. For example, fleet-based merchant discount portal 154 reduces the amount of processing overhead required in traditional payment transaction systems by providing an automated and more efficient solution for managing fuel merchant discounts in an open-loop system.

In some embodiments, fleet-based merchant discount portal 154 includes a fleet-based merchant discount program registration unit 310, a fleet-based merchant discount qualification assessment unit 320, a fleet-based merchant discount plan retrieval unit 330, a fleet-based merchant discount calculation and application unit 340, and a fleet-based merchant discount program restoration unit 350. In some embodiments, fleet-based merchant discount program registration unit 310, fleet-based merchant discount qualification assessment unit 320, fleet-based merchant discount plan retrieval unit 330, fleet-based merchant discount calculation and application unit 340, and fleet-based merchant discount program restoration unit 350 are collectively configured to perform fleet-based merchant discount portal operations described herein. The operation of fleet-based merchant discount portal 154 in FIG. 3 of payment processing network 150 in payment transaction system 100 is described further herein with reference to FIG. 1-FIG. 4.

### Registration of Fleet-Based Merchant Discount Program Participants

In some embodiments, in order to utilize the fleet-based merchant discount portal 154 to provide a fleet-based merchant discount to a fleet client 101 of merchant 130, merchant 130, acquirer 140, and issuer 160 must be registered with fleet-based merchant discount portal 154 of payment processing network 150. In some embodiments, merchant 130 must register with fleet-based merchant discount portal 154 to establish a fleet-based merchant discount program with fleet-based merchant discount portal 154, and acquirer 140 and issuer 160 must be registered with fleet-based merchant discount portal 154 to participate in the fleet-based merchant discount program established by merchant 130 at fleet-based merchant discount portal 154. In some embodiments, a participation flag has to be established for issuer 160 and acquirer 140 to participate in the fleet-based merchant discount program. In some embodiments, separately, a name, an address, and an ID type may be setup for the parties involved in the fleet-based merchant discount program. In some embodiments, fleet-based merchant discount program registration unit 310 is executable code configured to perform fleet-based merchant discount program registration operations for fleet-based merchant discount portal 154. In some embodiments, the fleet-based merchant discount program registration operations are registration operations required to register merchant 130, acquirer 140, and issuer 160 at fleet-based merchant discount program registration unit 310 to establish and implement the fleet-based merchant discount program at fleet-based merchant discount portal 154 of payment transaction system 100.

In some embodiments, the fleet-based merchant discount portal registration operations include, for example, ascertaining fleet-based merchant discount program details from merchant 130, acquirer 140, and issuer 160 required to establish and implement the fleet-based merchant discount program at fleet-based merchant discount portal 154; and ensuring that the fleet-based merchant discount program details ascertained from merchant 130, acquirer 140, and issuer 160 required to establish and implement the fleet-based merchant discount program at fleet-based merchant discount portal 154 are accurate.

In some embodiments, the fleet-based merchant discount program details may include, for example, a fleet-based merchant discount plan provided from merchant 130; fleet-based merchant discount program legal agreements executed by merchant 130, payment processing network 150, and/or fleet client 101; merchant account information required to provide a fleet-based merchant discount to a fleet-based vehicle energy payment transaction; acquirer account information required to provide a fleet-based merchant discount to a fleet-based vehicle energy payment transaction; and issuer account information required to provide a fleet-based merchant discount to a fleet-based vehicle energy payment transaction.

In some embodiments, as stated previously, a fleet-based merchant discount plan is a discount plan that includes fleet-based merchant discount information that is utilized by fleet-based merchant discount portal 154 to implement a fleet-based merchant discount for merchant 130. In some embodiments, the fleet-based merchant discount plan may include, for example, a fleet-based merchant discount amount associated with the fleet-based merchant discount program (e.g., a percentage that is to be deducted from a gross amount of a fleet-based vehicle energy payment transaction), an effective start date of the fleet-based merchant discount plan, fleet client information, and/or any other information that may be utilized to provide a fleet-based merchant discount to a fleet-based vehicle energy payment transaction. In some embodiments, fleet-based merchant discount program legal agreements may include, for example, client information questionnaire (CIQ) forms that have been executed by acquirer 140 and issuer 160.

In some embodiments, fleet-based merchant discount program registration unit 310 ensures that the fleet-based merchant discount program details have been provided from merchant 130, acquirer 140, and issuer 160 to establish and implement the fleet-based merchant discount program at fleet-based merchant discount portal 154 by confirming that the required fleet-based merchant discount program details are provided to and located at fleet-based merchant discount portal 154 for fleet-based vehicle energy payment transaction processing. In some embodiments, after the fleet-based merchant discount portal registration operations have been completed at fleet-based merchant discount portal 154, fleet-based merchant discount portal 154 of payment processing network 150 may be utilized to process authorized fleet-based merchant discounts for fleet-based vehicle energy payment transactions initiated by fleet vehicle driver 102 at access device 120 of merchant 130, as described herein.

### Processing Fleet-Based Merchant Discounts Utilizing the Fleet-Based Merchant Discount Portal 154 in Payment Transaction System 100

In some embodiments, in order to provide a fleet-based merchant discount to a fleet-based vehicle energy payment transaction in payment transaction system 100, fleet-based merchant discount portal 154 must authorize the fleet-based merchant discount for the fleet-based vehicle energy payment transaction initiated at access device 120 of merchant 130. In some embodiments, the process of authorizing the fleet-based merchant discount commences after fleet vehicle driver 102 initiates a fleet-based vehicle energy purchase utilizing fleet payment card 115 at access device 120 of merchant 130, an authorization request has been sent by merchant 130 to issuer 160 to authorize the use of the fleet payment card 115 for the fleet-based vehicle energy purchase, an authorization response has been sent to merchant 130 in response to the authorization request, the vehicle driver 102 has completed transferring the fleet-based vehicle energy to the fleet vehicle, and an advice message has been sent to fleet-based merchant discount portal 154 of payment processing network 150 in payment transaction system 100. In some embodiments, the advice message sent to fleet-based merchant discount portal 154 is an advice message utilized by fleet-based merchant discount qualification assessment unit 320 of the fleet-based merchant discount portal 154 to determine whether a fleet-based merchant discount is warranted for the fleet-based vehicle energy payment transaction associated with the advice message. In some embodiments, the advice message may be, for example, a confirmation advice message or a completion advice message. In some embodiments, a confirmation advice message is a confirmation advice message that is associated with a fleet-based vehicle energy payment transaction associated with a fleet-based vehicle energy purchase for a fleet-based vehicle made by fleet vehicle driver 102. In some embodiments, completion advice message is a completion advice message that is associated with a fleet-based vehicle energy payment transaction associated with a fleet-based vehicle energy purchase for a fleet-based vehicle made by fleet vehicle driver 102.

In some embodiments, the advice message provided to fleet-based merchant discount portal 154 includes, for example, a primary account number (PAN), a transaction amount, a transmission date, a transmission time, a merchant type, a product identification (ID), an acquirer identification code (e.g., acquiring institution identification code), a merchant identifier, an issuer identification code, a card acceptor identification code field, a tag length value (TLV), a usage value, and a dataset identification (ID) value. In some embodiments, the advice message may include a product code tag, a unit price tag, a unit of measure (UOM) tag, a unit price tag, a product quantity tag, a quantity minor unit tag, and a total amount including tax tag (e.g., gross price). In some embodiments, the advice message may include additional information that meets the standard operational requirements required for electronic payment transactions.

In some embodiments, the PAN, the transaction amount, the transmission date, the transmission time, the merchant type, the product ID, the acquirer identification code, the merchant identifier, the issuer identification code, the card acceptor identification code field, the TLV, the usage value, and the dataset ID value are located in a PAN field, a transaction amount field, a transmission date field, a transmission time field, a merchant type field, a product ID field, an acquirer identification code field, a merchant identifier field, an issuer identification code field, a card acceptor identification code field, a TLV field, a usage value field, and a dataset ID field of the advice message, respectively. In some embodiments, the product code tag, the unit price tag, the UOM tag, the product quantity tag, the quantity minor unit tag, and the total amount including tax tag (e.g., gross price) are located in a product code tag field, a unit price tag field, a UOM tag field, a unit price tag field, a product quantity tag field, a quantity minor unit tag field, and a total amount including tax tag field of the advice message, respectively.

In some embodiments, a merchant type may be, for example, a service station type (with or without ancillary services), an automated fuel dispenser type, or an electric vehicle charging type. In some embodiments, the merchant type may be represented using merchant category codes (MCCs). For example, an MCC of 5541 may be utilized to represent the service station type, an MCC of 5542 may be utilized to represent the automated fuel dispenser type, and an MCC of 5552 may be utilized to represent the electric vehicle charging type.

In some embodiments, the product ID may be, for example, a purchasing with fleet product ID (e.g., VISA purchasing with fleet product ID) or a government purchasing with fleet product ID (e.g., VISA government purchasing with fleet product ID). In some embodiments, product IDs may be represented as S1, S3 values. For example, S1 may be utilized to represent a purchasing with fleet product ID and S3 may be used to represent a government purchasing with fleet product ID.

In some embodiments, after the advice message is received by fleet-based merchant discount portal 154, fleet-based merchant discount qualification assessment unit 320 of fleet-based merchant discount portal 154 commences the process of determining if the fleet-based vehicle energy payment transaction qualifies for a fleet-based merchant discount. In some embodiments, fleet-based merchant discount qualification assessment unit 320 is executable code configured to perform a fleet-based merchant discount qualification assessment of a fleet-based vehicle energy payment transaction initiated by fleet vehicle driver 102 at access device 120 of merchant 130. In some embodiments, the fleet-based merchant discount qualification assessment is an assessment of the fleet-based vehicle energy payment transaction that utilizes fleet-based merchant discount qualification criteria to determine if a fleet-based merchant discount applies to the fleet-based vehicle energy payment transaction. In some embodiments, the fleet-based merchant discount qualification criteria are criteria utilized by fleet-based merchant discount qualification assessment unit 320 to determine whether the fleet-based vehicle energy payment transaction qualifies for a fleet-based merchant discount.

In some embodiments, the fleet-based merchant discount qualification criteria include, for example, a fleet-based merchant discount merchant type criteria, a fleet-based merchant discount participant criteria, a fleet-based merchant discount plan criteria, a fleet-based merchant-acquirer identification criteria, a fleet-based merchant discount expiration date criteria, a fleet-based merchant discount fuel type and UOM criteria, a fleet-based merchant discount transaction amount criteria, a fleet-based merchant discount product ID criteria, and/or a fleet-based merchant discount tag criteria. In some embodiments, when fleet-based merchant discount qualification assessment unit 320 determines that the fleet-based merchant discount qualification criteria have been satisfied, then a fleet-based merchant discount applies to the fleet-based vehicle energy payment transaction and operations proceed to the fleet-based merchant discount plan retrieval unit 330, described further herein.

In some embodiments, in order to utilize the fleet-based merchant discount qualification criteria to perform the fleet-based merchant discount qualification assessment, fleet-based merchant discount qualification assessment unit 320 includes a fleet-based merchant discount merchant type assessment unit 321, a fleet-based merchant discount program participant assessment unit 322, a fleet-based merchant discount plan assessment unit 323, a fleet-based merchant discount merchant-acquirer matching unit 324, a fleet-based merchant discount plan expiration assessment unit 325, a fleet-based merchant discount program fuel type and UOM assessment unit 326, a fleet-based merchant discount transaction amount assessment unit 327, a fleet-based merchant discount product identification (ID) assessment unit 328, and a fleet-based merchant discount tag assessment unit 329.

In some embodiments, in order to determine whether the fleet-based vehicle energy payment transaction satisfies the fleet-based merchant discount merchant type criteria, fleet-based merchant discount qualification assessment unit 320 utilizes fleet-based merchant discount merchant type assessment unit 321. In some embodiments, fleet-based merchant discount merchant type assessment unit 321 is executable code configured to perform a fleet-based merchant discount merchant type assessment of a merchant type associated with a fleet-based vehicle energy payment transaction initiated by fleet vehicle driver 102 at access device 120 of merchant 130. In some embodiments, the fleet-based merchant discount merchant type assessment is an assessment of a merchant type associated with a fleet-based vehicle energy payment transaction to determine whether the merchant type associated with the fleet-based vehicle energy payment transaction is authorized under a fleet-based merchant discount plan managed by fleet-based merchant discount portal 154.

In some embodiments, fleet-based merchant discount merchant type assessment unit 321 performs the fleet-based merchant discount merchant type assessment by determining whether an MCC associated with the fleet-based vehicle energy payment transaction qualifies as a fleet-based merchant discount MCC authorized under an associated fleet-based merchant discount plan at fleet-based merchant discount portal 154. In some embodiments, fleet-based merchant discount merchant type assessment unit 321 performs the fleet-based merchant discount merchant type assessment by comparing an MCC associated with the fleet-based vehicle energy payment transaction to authorized fleet-based merchant discount MCCs (e.g., MCCs authorized under a fleet-based merchant discount plan of a fleet-based merchant discount program associated with the fleet client 101 for a fleet-based vehicle energy payment transaction). For example, fleet-based merchant discount merchant type assessment unit 321 compares the MCC located provided in a merchant type field of the advice message associated with the fleet-based vehicle energy payment transaction to authorized fleet-based merchant discount MCCs associated with a fleet-based merchant discount plan. In some embodiments, the authorized fleet-based merchant discount MCCs may be provided in a fleet-based authorized MCC list stored at, for example, payment processing network computer 151. In some embodiments, authorized MCCs may include, for example, a service station MCC (e.g., 5541), an automated fuel dispenser MCC (e.g., 5542), or an electric vehicle charging MCC (e.g., 5552).

In some embodiments, when, as a result of the fleet-based merchant discount merchant type assessment, fleet-based merchant discount merchant type assessment unit 321 determines that the fleet-based merchant discount merchant type criteria has not been met, a fleet-based merchant discount is not applied to the fleet-based vehicle energy payment transaction by fleet-based merchant discount portal 154 and the fleet-based vehicle energy payment transaction is processed according to standard payment transaction processing. In some embodiments, when fleet-based merchant discount merchant type assessment unit 321 determines that the fleet-based merchant discount merchant type criteria has been met, fleet-based merchant discount qualification assessment operations proceed until all the fleet-based merchant discount qualification criteria are met or any of the fleet-based merchant discount qualification criteria are not met. In some embodiments, when any of the fleet-based merchant discount qualification criteria are not met, a fleet-based merchant discount is not applied to the fleet-based vehicle energy payment transaction by fleet-based merchant discount portal 154 and the fleet-based vehicle energy payment transaction is processed according to standard payment transaction processing in payment transaction system 100.

In some embodiments, in order to determine whether the fleet-based vehicle energy payment transaction satisfies the fleet-based merchant discount participant criteria, fleet-based merchant discount qualification assessment unit 320 utilizes fleet-based merchant discount program participant assessment unit 322. In some embodiments, fleet-based merchant discount program participant assessment unit 322 is executable code configured to perform a fleet-based merchant discount program participant assessment of the fleet-based vehicle energy payment transaction initiated by fleet vehicle driver 102 at access device 120 of merchant 130. In some embodiments, the fleet-based merchant discount program participant assessment is an assessment of the issuer and acquirer (e.g., acquirer 140 and issuer 160) associated with the fleet-based vehicle energy payment transaction to determine whether the issuer and acquirer are registered (e.g., enrolled and authorized to participate) in a fleet-based merchant discount program associated fleet-based vehicle energy payment transaction. In some embodiments, fleet-based merchant discount program participant assessment unit 322 performs the fleet-based merchant discount program participant assessment by comparing an acquirer identification code provided in an acquirer identification code field of the advice message associated with the fleet-based vehicle energy payment transaction to acquirer identification codes associated with an authorized list of acquirers that are enrolled in the fleet-based merchant discount program; and comparing an issuer identification code provided in an issuer identification code field of the advice message to issuer identification codes associated with an authorized list of issuers that are enrolled in the fleet-based merchant discount program. In some embodiments, when the acquirer identification code provided in an acquirer identification code field of the advice message associated with the fleet-based vehicle energy payment transaction matches with an acquirer identification code in the acquirer identification codes associated with an authorized list of acquirers that are enrolled in the fleet-based merchant discount program, the acquirer is considered registered with the fleet-based merchant discount program. Similarly, when the issuer identification code provided in an acquirer identification code field of the advice message associated with the fleet-based vehicle energy payment transaction matches with an issuer identification code in the acquirer identification codes associated with an authorized list of issuers that are enrolled in the fleet-based merchant discount program, the issuer is considered registered with the fleet-based merchant discount program. In some embodiments, when fleet-based merchant discount program participant assessment unit 322 determines that both the issuer and acquirer are registered with fleet-based merchant discount program, the fleet-based merchant discount participant criteria is satisfied.

In some embodiments, when, as a result of the fleet-based merchant discount program participant assessment, fleet-based merchant discount program participant assessment unit 322 determines that the fleet-based merchant discount participant criteria has not been met, a fleet-based merchant discount is not applied to the fleet-based vehicle energy payment transaction by fleet-based merchant discount portal 154 and the fleet-based vehicle energy payment transaction is processed according to standard payment transaction processing. In some embodiments, when fleet-based merchant discount program participant assessment unit 322 determines that the fleet-based merchant discount participant criteria has been met, fleet-based merchant discount qualification assessment operations proceed until all the fleet-based merchant discount qualification criteria are met or any of the fleet-based merchant discount qualification criteria are not met. In some embodiments, when any of the fleet-based merchant discount qualification criteria are not met, a fleet-based merchant discount is not applied to the fleet-based vehicle energy payment transaction by fleet-based merchant discount portal 154 and the fleet-based vehicle energy payment transaction is processed according to standard payment transaction processing in payment transaction system 100.

In some embodiments, in order to determine whether the fleet-based vehicle energy payment transaction satisfies the fleet-based merchant discount plan criteria, fleet-based merchant discount qualification assessment unit 320 utilizes fleet-based merchant discount plan assessment unit 323. In some embodiments, a fleet-based merchant discount plan assessment unit 323 is executable code configured to perform a fleet-based merchant discount plan assessment of a fleet-based vehicle energy payment initiated by fleet vehicle driver 102 at access device 120 of merchant 130. In some embodiments, a fleet-based merchant discount plan assessment is an assessment of a fleet-based vehicle energy payment transaction to determine if the fleet-based vehicle energy payment transaction is associated with a fleet-based merchant discount plan associated with a fleet-based merchant discount program managed by fleet-based merchant discount portal 154. In some embodiments, the fleet-based merchant discount plan assessment unit 323 performs the fleet-based merchant discount plan assessment by determining whether a PAN associated with a fleet-based vehicle energy payment transaction matches with a PAN associated with a fleet-based merchant discount plan (e.g., a fleet-based merchant discount plan PAN) or whether the PAN associated with a fleet-based vehicle energy payment transaction is within a fleet-based merchant discount plan PAN range in a fleet-based merchant discount plan table. In some embodiments, a fleet-based merchant discount plan table is a table that includes a list of fleet-based merchant discount program details, fleet-based merchant discount plan details, and other information associated with fleet-based merchant discount plans. For example, in some embodiments, fleet-based merchant discount plan table includes a list of authorized fleet-based merchant discount plans, a list of PANs associated with or mapped to the authorized fleet-based merchant discount plans, a list of product code IDs associated with or mapped to the authorized fleet-based merchant discount plans, and a list of merchant identifier pairings or card acceptor pairings associated with or mapped to the authorized fleet-based merchant discount plans, etc. For example, in some embodiments, fleet-based merchant discount plan assessment unit 323 performs the fleet-based merchant discount plan assessment by determining whether a PAN provided in a PAN field of an advice message received from acquirer computer 141 matches with a PAN associated with a fleet-based merchant discount plan listed in a fleet-based merchant discount plan table located at fleet-based merchant discount portal 154.

In some embodiments, when, as a result of the fleet-based merchant discount plan assessment, fleet-based merchant discount plan assessment unit 323 determines that the fleet-based merchant discount plan criteria has not been met, a fleet-based merchant discount is not applied to the fleet-based vehicle energy payment transaction by fleet-based merchant discount portal 154 and the fleet-based vehicle energy payment transaction is processed according to standard payment transaction processing. In some embodiments, when fleet-based merchant discount plan assessment unit 323 determines that the fleet-based merchant discount plan criteria has been met, fleet-based merchant discount qualification assessment operations proceed until all the fleet-based merchant discount qualification criteria are met or any of the fleet-based merchant discount qualification criteria are not met. In some embodiments, when any of the fleet-based merchant discount qualification criteria are not met, a fleet-based merchant discount is not applied to the fleet-based vehicle energy payment transaction by fleet-based merchant discount portal 154 and the fleet-based vehicle energy payment transaction is processed according to standard payment transaction processing in payment transaction system 100.

In some embodiments, in order to determine whether the fleet-based vehicle energy payment transaction satisfies the fleet-based merchant-acquirer identification criteria, fleet-based merchant discount portal 154 utilizes fleet-based merchant discount merchant-acquirer matching unit 324 of fleet-based merchant discount qualification assessment unit 320. In some embodiments, fleet-based merchant discount merchant-acquirer matching unit 324 is executable code configured to perform a fleet-based merchant-acquirer identification assessment of the merchant and acquirer (e.g., merchant 130 and acquirer 140) associated with the fleet-based vehicle energy payment transaction.

In some embodiments, fleet-based merchant discount merchant-acquirer matching unit 324 performs fleet-based merchant-acquirer identification assessment of the merchant and acquirer associated with the fleet-based vehicle energy payment transaction by determining whether a merchant identification (MID) or acquirer BIN/card acceptor identification (CAID) associated with the fleet-based vehicle energy payment transaction matches with an authorized MID or acquirer BIN/CAID (e.g., MID or acquirer BIN/CAID authorized under a fleet-based merchant discount program and stored in an authorized MID or acquirer BIN/CAID list at the fleet-based merchant discount portal 154). In some embodiments, the MID is a unique identifier assigned to merchant 130 within a payment transaction system 100 that allows for the acceptance of payments. In some embodiments, the MID may be a Visa merchant identification, e.g., VMID. In some embodiments, the acquirer BIN is a bank identification number assigned to acquirer 140 (e.g., the acquiring bank or financial institution). In some embodiments, acquirer CAID is a card acceptor ID specific to the acquirer 140 that uniquely identifies and represents the merchant 130 that is accepting card payments through acquirer 140. In some embodiments, when fleet-based merchant discount merchant-acquirer matching unit 324 determines that the MID or acquirer BIN/CAID provided in the advice message match with authorized MID or acquirer BIN/CAID, the fleet-based merchant-acquirer identification criteria is satisfied.

In some embodiments, when, as a result of the fleet-based merchant-acquirer identification assessment, fleet-based merchant discount merchant-acquirer matching unit 324 determines that the fleet-based merchant-acquirer identification criteria has not been met, a fleet-based merchant discount is not applied to the fleet-based vehicle energy payment transaction by fleet-based merchant discount portal 154 and the fleet-based vehicle energy payment transaction is processed according to standard payment transaction processing. In some embodiments, when fleet-based merchant discount merchant-acquirer matching unit 324 determines that the fleet-based merchant-acquirer identification criteria has been met, fleet-based merchant discount qualification assessment operations proceed until all the fleet-based merchant discount qualification criteria are met or any of the fleet-based merchant discount qualification criteria are not met. In some embodiments, when any of the fleet-based merchant discount qualification criteria are not met, a fleet-based merchant discount is not applied to the fleet-based vehicle energy payment transaction by fleet-based merchant discount portal 154 and the fleet-based vehicle energy payment transaction is processed according to standard payment transaction processing in payment transaction system 100.

In some embodiments, in order to determine whether the fleet-based vehicle energy payment transaction satisfies the fleet-based merchant discount plan expiration criteria, fleet-based merchant discount portal 154 utilizes fleet-based merchant discount plan expiration assessment unit 325 of fleet-based merchant discount qualification assessment unit 320. In some embodiments, fleet-based merchant discount plan expiration assessment unit 325 is executable code configured to perform a fleet-based merchant discount plan expiration date assessment of a purchase date (e.g., transmission date or transaction date of the purchase) associated with a fleet-based vehicle energy payment transaction initiated by fleet vehicle driver 102 at merchant 130. In some embodiments, fleet-based merchant discount program expiration date assessment is an assessment of a transmission date associated with a fleet-based vehicle energy payment transaction to determine if the purchase date has occurred prior to a fleet-based merchant discount program expiration date of the fleet-based merchant discount program (e.g., whether the fleet-based merchant discount program has expired). In some embodiments, fleet-based merchant discount plan expiration assessment unit 325 performs the fleet-based merchant discount program expiration assessment by comparing the purchase date (e.g., transmission date of the transaction provided in the advice message) associated with the fleet-based vehicle energy payment transaction with a fleet-based merchant discount program date expiration date associated with a fleet-based discount plan associated with the fleet-based vehicle energy payment transaction. In some embodiments, if fleet-based merchant discount plan expiration assessment unit 325 determines that the transmission date is after the expiration date of the fleet-based merchant discount plan or fleet-based merchant discount program, the fleet-based merchant discount plan expiration criteria is not met.

In some embodiments, when, as a result of the fleet-based merchant discount program expiration date assessment, fleet-based merchant discount plan expiration assessment unit 325 determines that the fleet-based merchant discount plan expiration criteria has not been met, a fleet-based merchant discount is not applied to the fleet-based vehicle energy payment transaction by the fleet-based merchant discount portal 154 and the fleet-based vehicle energy payment transaction is processed according to standard payment transaction processing. In some embodiments, when fleet-based merchant discount plan expiration assessment unit 325 determines that the fleet-based merchant discount plan expiration criteria has been met, fleet-based merchant discount qualification assessment operations proceed until all the fleet-based merchant discount qualification criteria are met or any of the fleet-based merchant discount qualification criteria are not met. In some embodiments, when any of the fleet-based merchant discount qualification criteria are not met, a fleet-based merchant discount is not applied to the fleet-based vehicle energy payment transaction by fleet-based merchant discount portal 154 and the fleet-based vehicle energy payment transaction is processed according to standard payment transaction processing in payment transaction system 100.

In some embodiments, in order to determine whether the fleet-based vehicle energy payment transaction satisfies the fleet-based merchant discount fuel type and UOM criteria, fleet-based merchant discount portal 154 utilizes fleet-based merchant discount fuel type and UOM assessment unit 326 of fleet-based merchant discount qualification assessment unit 320. In some embodiments, fleet-based merchant discount fuel type and UOM assessment unit 326 is executable code configured to perform a fleet-based merchant discount fuel type and UOM assessment of the fuel type and UOM associated with the fleet-based vehicle energy payment transaction. In some embodiments, the fleet-based merchant discount fuel type and UOM assessment is an assessment of the fuel type and UOM associated with a fleet-based vehicle energy payment transaction to determine if the fuel type and UOM associated with the fleet-based vehicle energy payment transaction match with a fleet-based merchant discount program fuel type and UOM authorized under the associated fleet-based merchant discount program. In some embodiments, the authorized fleet-based merchant discount program fuel types and UOMs associated with a fleet-based merchant discount program are stored in a fleet-based merchant discount program fuel type and UOM table. In some embodiments, fleet-based merchant discount fuel type and UOM assessment unit 326 performs the fleet-based merchant discount program fuel type and UOM assessment by comparing the fleet-based merchant discount program fuel type and UOM with the authorized fleet-based merchant discount program fuel type and UOM stored in the fleet-based merchant discount program fuel type and UOM table associated with the fleet-based merchant discount plan associated with the fleet-based merchant discount program. In some embodiments, when the fleet-based merchant discount fuel type and UOM assessment unit 326 determines that the fleet-based merchant discount program fuel type and UOM match with the authorized fleet-based merchant discount program fuel type and UOM stored in the fleet-based merchant discount program fuel type and UOM table associated with the fleet-based merchant discount plan, the fleet-based merchant discount fuel type and UOM criteria has been met.

In some embodiments, when, as a result of the fleet-based merchant discount fuel type and UOM assessment, fleet-based merchant discount fuel type and UOM assessment unit 326 determines that the fleet-based merchant discount fuel type and UOM criteria has not been met, a fleet-based merchant discount is not applied to the fleet-based vehicle energy payment transaction and the fleet-based vehicle energy payment transaction is processed according to standard payment transaction processing. In some embodiments, when fleet-based merchant discount fuel type and UOM assessment unit 326 determines that the fleet-based merchant discount fuel type and UOM criteria has been met, fleet-based merchant discount qualification assessment operations proceed until all the fleet-based merchant discount qualification criteria are met or any of the fleet-based merchant discount qualification criteria are not met. In some embodiments, when any of the fleet-based merchant discount qualification criteria are not met, a fleet-based merchant discount is not applied to the fleet-based vehicle energy payment transaction and the fleet-based vehicle energy payment transaction is processed according to standard payment transaction processing in payment transaction system 100.

In some embodiments, in order to determine whether the fleet-based vehicle energy payment transaction satisfies the fleet-based merchant discount transaction amount criteria, fleet-based merchant discount portal 154 utilizes fleet-based merchant discount transaction amount assessment unit 327 of fleet-based merchant discount qualification assessment unit 320. In some embodiments, fleet-based merchant discount transaction amount assessment unit 327 is executable code configured to perform a fleet-based merchant discount transaction amount assessment of the fleet-based vehicle energy payment transaction. In some embodiments, fleet-based merchant discount transaction amount assessment is a final transaction amount assessment of a transaction amount associated with a fleet-based vehicle energy payment transaction initiated by fleet vehicle driver 102 at merchant 130. In some embodiments, fleet-based merchant discount transaction amount assessment is performed by fleet-based merchant discount transaction amount assessment unit 327 to ensure that the transaction amount provided advice message is the final transaction amount (pre-discount) associated with the fleet-based vehicle energy payment transaction. In some embodiments, fleet-based merchant discount transaction amount assessment unit 327 performs the fleet-based merchant discount transaction amount assessment by comparing a transaction amount located in the transaction amount field in the advice message with a final transaction amount associated with the fleet-based vehicle energy payment transaction and ensuring that the transaction amount field is populated with a final transaction amount for the fleet-based vehicle energy payment transaction.

In some embodiments, when, as a result of the fleet-based merchant discount transaction amount assessment, fleet-based merchant discount transaction amount assessment unit 327 determines that the fleet-based merchant discount transaction amount criteria has not been met, a fleet-based merchant discount is not applied to the fleet-based vehicle energy payment transaction and the fleet-based vehicle energy payment transaction is processed according to standard payment transaction processing. In some embodiments, when fleet-based merchant discount transaction amount assessment unit 327 determines that the fleet-based merchant discount transaction amount criteria has been met, fleet-based merchant discount qualification assessment operations proceed until all the fleet-based merchant discount qualification criteria are met or any of the fleet-based merchant discount qualification criteria are not met. In some embodiments, when any of the fleet-based merchant discount qualification criteria are not met, a fleet-based merchant discount is not applied to the fleet-based vehicle energy payment transaction and the fleet-based vehicle energy payment transaction is processed according to standard payment transaction processing in payment transaction system 100.

In some embodiments, in order to determine whether the fleet-based vehicle energy payment transaction satisfies the fleet-based merchant discount product ID criteria, fleet-based merchant discount portal 154 utilizes fleet-based merchant discount product ID assessment unit 328 of fleet-based merchant discount qualification assessment unit 320. In some embodiments, fleet-based merchant discount product ID assessment unit 328 is executable code configured to perform a fleet-based merchant discount product ID assessment of a fleet-based vehicle energy payment transaction initiated by fleet vehicle driver 102 at merchant 130. In some embodiments, a fleet-based merchant discount product ID assessment is an assessment of a product ID associated with a fleet-based vehicle energy payment transaction to ensure that the product ID provided in the advice message provided from acquirer 140 is an authorized product ID for the fleet-based vehicle energy payment transaction. In some embodiments, fleet-based merchant discount product ID assessment unit 328 performs the fleet-based merchant product ID assessment by comparing the product ID provided in the advice message with a list of fleet-based merchant discount product IDs that are authorized in a fleet-based merchant discount plan of fleet-based merchant discount program associated with the fleet-based vehicle energy payment transaction. In some embodiments, when fleet-based merchant discount portal 154 determines that the product ID provided in the advice message matches with a product ID located in a list of fleet-based merchant discount product IDs that are authorized in a fleet-based merchant discount plan of fleet-based merchant discount program associated with the fleet-based vehicle energy payment transaction, the fleet-based merchant discount product ID criteria has been met.

In some embodiments, when, as result of the fleet-based merchant discount product ID assessment, fleet-based merchant discount product ID assessment unit 328 determines that the fleet-based merchant discount product ID criteria has not been met, a fleet-based merchant discount is not applied to the fleet-based vehicle energy payment transaction by fleet-based merchant discount portal 154 and the fleet-based vehicle energy payment transaction is processed according to standard payment transaction processing. In some embodiments, when fleet-based merchant discount product ID assessment unit 328 determines that the fleet-based merchant discount product ID criteria has been met, fleet-based merchant discount qualification assessment operations proceed until all the fleet-based merchant discount qualification criteria are met or any of the fleet-based merchant discount qualification criteria are not met. In some embodiments, when any of the fleet-based merchant discount qualification criteria are not met, a fleet-based merchant discount is not applied to the fleet-based vehicle energy payment transaction by fleet-based merchant discount portal 154 and the fleet-based vehicle energy payment transaction is processed according to standard payment transaction processing in payment transaction system 100.

In some embodiments, in order to determine whether the fleet-based vehicle energy payment transaction satisfies the fleet-based merchant discount tag criteria, fleet-based merchant discount portal 154 utilizes fleet-based merchant discount tag assessment unit 329 of fleet-based merchant discount qualification assessment unit 320. In some embodiments, fleet-based merchant discount tag assessment unit 329 is executable code configured to perform a fleet-based merchant discount program tag assessment of fleet-based merchant discount tags associated with a fleet-based vehicle energy payment transaction initiated by fleet vehicle driver 102 at merchant 130. In some embodiments, the fleet-based merchant discount program tag assessment is an assessment of tags provided in an advice message associated with a fleet-based vehicle energy payment transaction. In some embodiments, fleet-based merchant discount tag assessment unit 329 performs the fleet-based merchant discount tag assessment by comparing the tags in the advice message with a list of mandated fleet-based merchant discount tags required for a fleet-based merchant discount and ensuring that the tags in the advice message match with tags in the list of mandated fleet-based merchant discount tags required for a fleet-based merchant discount. In some embodiments, when fleet-based merchant discount tag assessment unit 329 determines that the tags in the advice message match with the tags in the list of mandated fleet-based merchant discount tags required for a fleet-based merchant discount, the fleet-based merchant discount tag criteria has been met, otherwise the fleet-based merchant discount tag criteria has not been met. In some embodiments, the mandated fleet-based merchant discount tags include, for example, a product code tag and a UOM tag.

In some embodiments, when, as a result of the fleet-based merchant discount tag assessment, fleet-based merchant discount tag assessment unit 329 determines that the fleet-based merchant discount tag criteria has not been met, a fleet-based merchant discount is not applied to the fleet-based vehicle energy payment transaction by fleet-based merchant discount portal 154 and the fleet-based vehicle energy payment transaction is processed according to standard payment transaction processing.

In some embodiments, when, as a result of the fleet-based merchant discount tag assessment, fleet-based merchant discount tag assessment unit 329 determines that the fleet-based merchant discount tag criteria has been met, fleet-based merchant discount qualification assessment operations proceed until all the fleet-based merchant discount qualification criteria are met or any of the fleet-based merchant discount qualification criteria are not met. In some embodiments, when all the fleet-based merchant discount qualification criteria are met, operations proceed to retrieving the fleet-based merchant discount plan associated with the fleet-based vehicle payment transaction, as described further herein.

### Retrieving the Fleet-Based Merchant Discount Plan

In some embodiments, when fleet-based merchant discount qualification assessment unit 320 determines that all the fleet-based merchant discount qualification criteria are met, operations at fleet-based merchant discount portal 154 proceed to fleet-based merchant discount plan retrieval unit 330. In some embodiments, fleet-based merchant discount plan retrieval unit 330 is executable code configured to retrieve a fleet-based merchant discount plan from fleet-based merchant discount portal 154 associated with the fleet-base vehicle energy payment transaction. In some embodiments, the fleet-based merchant discount plan is utilized by fleet-based merchant discount portal 154 to provide the fleet-based merchant discount associated with a fleet-based vehicle energy payment transaction to fleet vehicle driver 102 for merchant 130. In some embodiments, fleet-based merchant discount plan retrieval unit 330 retrieves a fleet-based merchant discount plan by scanning a fleet-based merchant discount plan table for a fleet-based merchant discount plan associated with a PAN received in the advice message associated with the fleet-based vehicle energy payment transaction, a product code ID received in the advice message associated with the fleet-based vehicle energy payment transaction, and a pairing of an acquiring institution identification code and merchant identifier associated with fleet-based vehicle energy payment transaction (e.g., merchant identifier pairing) or a pairing of an acquiring institution identification code and card acceptor identification code (e.g., card acceptor pairing). In some embodiments, if both the merchant identifier pairing and the card acceptor pairing are provided in the advice message associated with the fleet-based vehicle energy payment transaction, the merchant identifier pairing takes precedence over the card acceptor pairing for accessing the fleet-based merchant discount plan. In some embodiments, when fleet-based merchant discount plan retrieval unit 330 finds the fleet-based merchant discount plan with the PAN, product code ID, and pairing in fleet-based merchant discount plan table that matches the PAN, product code ID, and merchant identifier pairing or card acceptor pairing of the advice message, the corresponding fleet-based merchant discount plan is retrieved from memory at payment processing network computer 151 for use in, for example, calculating the fleet-based merchant discount and applying the fleet-based merchant discount to the fleet-based vehicle energy payment transaction, as described herein. In some embodiments, when the aforementioned matching is occurring, UOM is part of the matching process, not just the product code ID.

### Calculating, Applying, and Updating the Fleet-Based Merchant Discount

In some embodiments, after the fleet-based merchant discount plan has been retrieved by fleet-based merchant discount plan retrieval unit 330, operations at fleet-based merchant discount portal 154 proceed to processing the fleet-based merchant discount payment transaction utilizing fleet-based merchant discount calculation and application unit 340. In some embodiments, fleet-based merchant discount calculation and application unit 340 is executable code configured to calculate a fleet-based merchant discount amount of a fleet-based vehicle energy payment transaction, apply the fleet-based merchant discount amount to a transaction amount of the fleet-based vehicle energy payment transaction, and update the transaction amount to a discounted payment transaction amount. In some embodiments, fleet-based merchant discount calculation and application unit 340 includes a fleet-based merchant discount calculation unit 341, a fleet-based merchant discount application unit 342, and a fleet-based merchant discount transaction amount update unit 343, as described further herein.

In some embodiments, fleet-based merchant discount calculation unit 341 is executable code configured to calculate a fleet-based merchant discount amount associated with an authorized fleet-based merchant discount of a fleet-based vehicle energy payment transaction that is associated with the fleet payment card 115. In some embodiments, fleet-based merchant discount calculation unit 341 calculates the fleet-based merchant discount amount by multiplying a fleet-based merchant discount percentage amount associated with a fleet-based merchant discount (provided in the fleet-based merchant discount plan) with the transaction amount (e.g., gross fuel price) associated with the fleet-based vehicle energy payment transaction. In some embodiments, for example, for a fleet-based merchant discount percentage amount of 10% and a transaction amount of $100, the fleet-based merchant discount amount is $10. In some embodiments, fleet-based merchant discount calculation unit 341 provides the fleet-based merchant discount amount to fleet-based merchant discount application unit 342. In some embodiments, other types of fleet-based merchant discount calculation scenarios may be utilized, such as, for example, a cents per gallon scenario or a flat rate scenario and all 3 scenarios can be combined in any which way.

In some embodiments, fleet-based merchant discount application unit 342 receives the fleet-based merchant discount amount from fleet-based merchant discount calculation unit 341 and applies the fleet-based merchant discount amount to the fleet-based vehicle energy payment transaction. In some embodiments, fleet-based merchant discount application unit 342 is executable code configured to apply the fleet-based vehicle energy payment transaction amount calculated by fleet-based merchant discount calculation unit 341 to the transaction amount associated with the fleet-based vehicle energy payment transaction. In some embodiments, fleet-based merchant discount application unit 342 applies the fleet-based merchant discount amount to the fleet-based vehicle energy payment transaction by subtracting the fleet-based merchant discount amount from the transaction amount of the advice message to yield a fleet-based merchant discount payment transaction amount.

In some embodiments, after the fleet-based merchant discount amount has been calculated and applied by fleet-based merchant discount calculation unit 341 and fleet-based merchant discount application unit 342, operations proceed to merchant discount transaction amount update unit 343. In some embodiments, fleet-based merchant discount transaction amount update unit 343 is executable code configured to update the advice message of the fleet-based vehicle energy payment transaction to generate a fleet-based merchant discount advice message. In some embodiments, the fleet-based merchant discount advice message is an advice message that includes fleet-based merchant discount information specific to the associated fleet-based merchant discount plan. For example, in some embodiments, fleet-based merchant discount transaction amount update unit 343 updates the advice message by updating the transaction amount associated with the fleet-based merchant discount program payment transaction in the advice message with the fleet-based merchant discount payment transaction amount. In some embodiments, fleet-based merchant discount transaction amount update unit 343 may also update additional discount field details in the advice message. For example, in some embodiments, in addition to including the fleet-based merchant discount payment transaction amount, the fleet-based merchant discount advice message provided to issuer 160 includes a discounted amount, a total discounted amount, an amount type, a sum of all discount amounts associated with the fleet-based vehicle energy payment transaction, any tags included in the advice message received from acquirer 140, a net fuel price tag (e.g., a net fuel price containing a sum of net fuel prices for all fuel codes contained in the fleet-based vehicle energy payment transaction), a discounted method, a discount agent, a discount plan ID, a client ID, a discounted rate-percentage, a discount rate-unit discount, a discount rate-flat rate per transaction, a total discount amount, and a net amount (e.g., net price). In some embodiments, the discounted method, the discount agent, the discount plan ID, the client ID, the discounted rate-percentage, the discount rate-unit discount, a discount rate-flat rate per transaction, the total discount amount, and the net amount (e.g., net price) are provided in a net fuel price tag (e.g., a net fuel price containing a sum of net fuel prices for all fuel codes contained in the fleet-based vehicle energy payment transaction), a discounted method tag, a discount agent tag, a discount plan ID tag, a client ID tag, a discounted rate-percentage tag, a discount rate-unit discount tag, a discount rate-flat rate per transaction tag, a total discount amount tag, a net amount tag (e.g., net price tag), respectively. In some embodiments, after updating the transaction amount associated with the fleet-based merchant discount payment transaction with the fleet-based merchant discount payment transaction amount in the advice message, fleet-based merchant discount portal 154 provides the fleet-based merchant discount advice message to issuer 160.

In some embodiments, after receiving the fleet-based merchant discount advice message, issuer 160 issues and provides a fleet-based merchant discount advice response to fleet-based merchant discount portal 154. In some embodiments, a fleet-based merchant discount advice response is an advice response generated based on the fleet-based merchant discount advice message received from fleet-based merchant discount portal 154.

In some embodiments, fleet-based merchant discount program restoration unit 350 of fleet-based merchant discount portal 154 receives the fleet-based merchant discount advice response from issuer 160 of payment transaction system 100. In some embodiments, fleet-based merchant discount program restoration unit 350 is executable code configured to restore fleet-based merchant discount information to acquirer 140. In some embodiments, fleet-based merchant discount program restoration unit 350 receives the fleet-based merchant discount advice response (that is generated in response to and based on the fleet-based merchant discount advice message) from issuer 160 and restores fleet-based merchant discount information on the fleet-based merchant discount advice response (i.e., fleet-based merchant discount advice response message) provided to fleet-based merchant discount portal 154 by issuer 160. In some embodiments, fleet-based merchant discount program restoration unit 350 may disregard any discount-related tags added and sent by issuer 160 to fleet-based merchant discount program restoration unit 350 in the fleet-based merchant discount advice response message. In some embodiments, fleet-based merchant discount portal 154 provides a restored fleet-based merchant discount advice response message to acquirer 140. In some embodiments, the restored fleet-based merchant discount advice response message sent by the fleet-based merchant discount portal 154 to acquirer 140 includes fleet-based merchant discount information such as, for example, the discounted amount (e.g., fleet-based merchant discount payment transaction amount), discount-related tags added by the fleet-based merchant discount portal 154, and the tags received in the original advice message received from acquirer 140.

In some embodiments, acquirer 140 receives the restored fleet-based merchant discount advice response message from fleet-based merchant discount portal 154 and transmits clearing data with the fleet-based merchant discount transaction amount and applicable discount-related fields and information to issuer 160 via payment processing network 150 for settlement. In some embodiments, using the operations described herein, merchant 130 utilizes fleet-based merchant discount portal 154 to provide a fleet-based merchant discount to fleet vehicle driver 102 for fleet client 101.

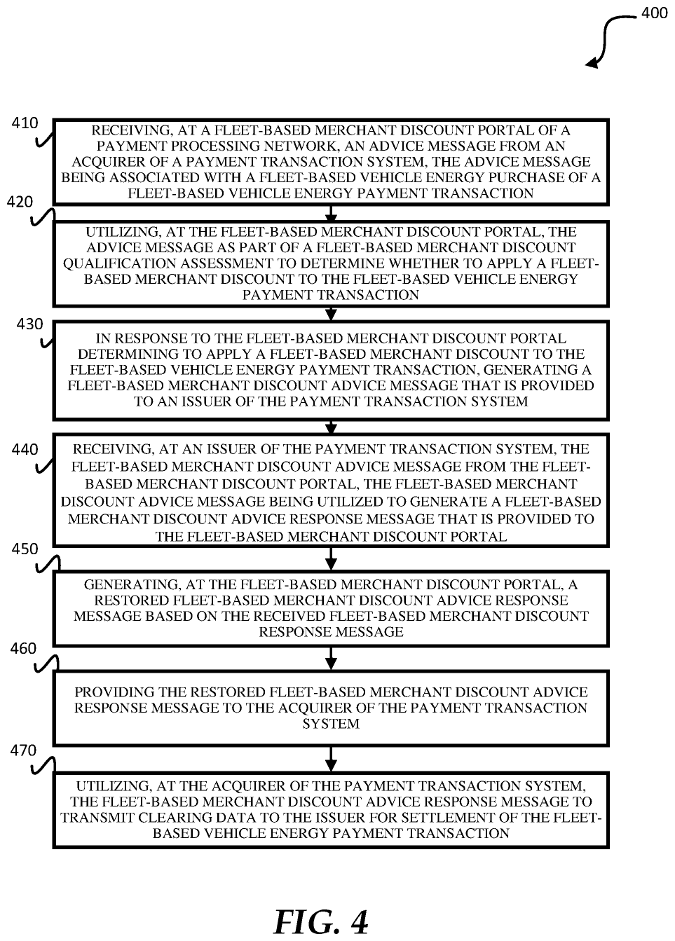

FIG. 4 is a flow diagram illustrating a fleet-based merchant discount application method 400 in accordance with some embodiments. In some embodiments, the fleet-based merchant discount application method 400 is a method utilized by fleet-based merchant discount portal 154 to implement a fleet-based merchant discount for fleet vehicle driver 102 on behalf of merchant 130. The method, process steps, or stages illustrated in the figures may be implemented as an independent routine or process, or as part of a larger routine or process. Note that each process step or stage depicted may be implemented as an apparatus that includes a processor executing a set of instructions, a method, or a system, among other embodiments. In some embodiments, the fleet-based merchant discount application method 400 is described with reference to the figures described herein.

In some embodiments, at operation 410, with reference to FIG. 1-FIG. 4, fleet-based merchant discount portal 154 receives an advice message from acquirer 140. In some embodiments, fleet-based merchant discount portal 154 receives the advice message as part of a fleet-based vehicle energy payment transaction that is initiated by fleet vehicle driver 102 at access device 120 of merchant 130 during a fleet-based vehicle energy purchase. In some embodiments, after receiving the advice message from acquirer 140, operation 410 proceeds to operation 420.

In some embodiments, at operation 420, fleet-based merchant discount portal 154 utilizes the advice message received from acquirer 140 to determine whether to apply a fleet-based merchant discount to the fleet-based vehicle energy payment transaction. In some embodiments, as stated previously, fleet-based merchant discount portal 154 performs a fleet-based merchant discount qualification assessment to determine whether to apply a fleet-based merchant discount to the fleet-based vehicle energy payment transaction. In some embodiments, after performing the fleet-based merchant discount qualification assessment, operation 420 proceeds to operation 430.

In some embodiments, at operation 430, in response to fleet-based merchant discount portal 154 determining to apply a fleet-based merchant discount to the fleet-based vehicle energy payment transaction, fleet-based merchant discount portal 154 generates a fleet-based merchant discount advice message that is provided to issuer 160. In some embodiments, the fleet-based merchant discount advice message is an advice message that includes fleet-based merchant discount information specific to the associated fleet-based merchant discount plan. In some embodiments, after providing the fleet-based merchant discount advice message to issuer 160, operation 430 proceeds to operation 440.

In some embodiments, at operation 440, issuer 160 receives the fleet-based merchant discount advice message from fleet-based merchant discount portal 154 and generates a fleet-based merchant discount advice response. In some embodiments, as stated previously, issuer 160 generates the fleet-based merchant discount advice response based on the fleet-based merchant discount advice message received from fleet-based merchant discount portal 154. In some embodiments, after generating the fleet-based merchant discount advice response, issuer 160 provides the fleet-based merchant discount advice response to fleet-based merchant discount portal 154. In some embodiments, operation 440 proceeds to operation 450.

In some embodiments, at operation 450, fleet-based merchant discount portal 154 receives the fleet-based merchant discount advice response from issuer 160 and generates a restored fleet-based merchant discount advice response message. In some embodiments, as described previously, fleet-based merchant discount portal 154 restores fleet-based merchant discount information to the fleet-based merchant discount advice response to generate the restored fleet-based merchant discount advice response message. In some embodiments, operation 450 proceeds to operation 460.

In some embodiments, at operation 460, fleet-based merchant discount portal 154 provides the restored fleet-based merchant discount advice response message to acquire 140. In some embodiments, at operation 470, acquirer 140 receives the restored fleet-based merchant discount advice response message from fleet-based merchant discount portal 154 and transmits, via fleet-based merchant discount portal 154, clearing data (with the fleet-based merchant discount transaction amount and applicable discount-related fields and information) to issuer 160 via payment processing network 150 for settlement of the fleet-based vehicle energy payment transaction.

In some embodiments, for a BASE II system, acquirer computer 141 submits a TC 05 transaction that includes a discounted amount. In some embodiments, the discounted amount may be the amount received in, for example, a field of a corresponding confirmation advice response message. In some embodiments, acquirer computer 141 includes fields and values, as applicable and supported in a clearing record of a transaction, such as, for example, (1) a service type, when applicable; (2) a gross fuel price; (3) the net fuel price (containing the discounted fuel amount received); (4) the total discount amount; (5) a value representing a discount agent (such as, for example, V for Visa); and (6) a client identifier.

In some embodiments, for, for example, a full-service issuer, fleet-based merchant discount portal 154 of payment processing network computer 151 converts the TC 05 to an advice message (e.g., 0220 advice message) containing the discounted transaction amount in a field of the advice message (e.g., field 4 of the advice message). In some embodiments, for an authorization-only issuer, payment processing network 150 sends the TC 05 to the issuer 160 containing the values and transaction component records (TCR) received from an acquirer 140.

In some embodiments, a computer-implemented method includes receiving, at a fleet-based merchant discount portal of a payment processing network, an advice message from an acquirer, the advice message being associated with a fleet-based vehicle energy purchase initiated at an access device of a merchant; performing, at the fleet-based merchant discount portal, a fleet-based merchant discount qualification assessment of the advice message to determine whether to apply a fleet-based merchant discount to the fleet-based vehicle energy purchase; and in response to the fleet-based merchant discount qualification assessment yielding that the fleet-based merchant discount is warranted, utilizing a fleet-based merchant discount advice message to execute the fleet-based merchant discount on the fleet-based vehicle energy purchase, the fleet-based merchant discount advice message being generated by adding fleet-based merchant discount fields to the advice message to discount the fleet-based vehicle energy purchase.

In some embodiments, the computer-implemented method further includes generating a restored fleet-based merchant discount advice response message at the fleet-based merchant discount portal in response to receiving an advice response message at the fleet-based merchant discount portal.

In some embodiments, the computer-implemented method further includes transmitting the restored fleet-based merchant discount advice response message to the acquirer for use in clearing the fleet-based vehicle energy purchase.

In some embodiments of the computer-implemented method, when the fleet-based merchant discount qualification assessment yields that the fleet-based merchant discount is not warranted, the fleet-based merchant discount is not applied to the fleet-based vehicle energy purchase.

In some embodiments of the computer-implemented method, the fleet-based vehicle energy purchase is discounted according to a fleet-based merchant discount plan.

In some embodiments of the computer-implemented method, the fleet-based merchant discount plan is registered with a fleet-based merchant discount program at the payment processing network prior to applying the fleet-based merchant discount.

In some embodiments of the computer-implemented method, the fleet-based vehicle energy purchase is at least one of a fuel purchase and an electricity purchase.

In some embodiments of the computer-implemented method, the fleet-based merchant discount qualification assessment includes confirming that an issuer and the acquirer have registered to participate in a fleet-based merchant discount program associated with the fleet-based merchant discount.

In some embodiments, a system includes a processor; and a non-transitory computer readable medium coupled to the processor, the non-transitory computer readable medium including code that: receives an advice message from an acquirer, the advice message being associated with a fleet-based vehicle energy purchase by a vehicle driver of a fleet vehicle; performs a fleet-based merchant discount qualification assessment of the advice message to determine whether to apply a fleet-based merchant discount to the fleet-based vehicle energy purchase; adds fleet-based merchant discount fields to the advice message in order to discount the fleet-based vehicle energy purchase when the fleet-based merchant discount qualification assessment yields that the fleet-based merchant discount is warranted, the addition of the fleet-based merchant discount fields creating a fleet-based merchant discount advice message; and utilizes the fleet-based merchant discount advice message to perform the fleet-based merchant discount.

In some embodiments of the system, the non-transitory computer readable medium further includes code that: generates a restored fleet-based merchant discount advice response message in response to receiving an advice response message at the system.

In some embodiments of the system, the non-transitory computer readable medium further includes code that: transmits the restored fleet-based merchant discount advice response message to the acquirer for use in clearing the fleet-based vehicle energy purchase.

In some embodiments of the system, when the fleet-based merchant discount qualification assessment yields that the fleet-based merchant discount is not warranted, the fleet-based merchant discount is not applied to the fleet-based vehicle energy purchase.

In some embodiments of the system, the fleet-based vehicle energy purchase is discounted according to a fleet-based merchant discount plan.

In some embodiments of the system, the fleet-based merchant discount plan is registered at the system prior to applying the fleet-based merchant discount.

In some embodiments of the system, the fleet-based vehicle energy purchase is at least one of a fuel purchase and an electricity purchase.

In some embodiments of the system, the fleet-based merchant discount qualification assessment includes confirming that an issuer and the acquirer have registered to participate in a fleet-based merchant discount program associated with the fleet-based merchant discount.

In some embodiments, a payment processing network includes a fleet-based merchant discount qualification unit; and a fleet-based merchant discount calculation and application unit, wherein, based upon a fleet-based merchant discount qualification assessment by the fleet-based merchant discount qualification unit of an advice message received at the payment processing network, the fleet-based merchant discount calculation and application unit utilizes the advice message to calculate a fleet-based merchant discount of a fleet-based vehicle energy purchase, the advice message being updated to include fleet-based merchant discount fields to discount the fleet-based vehicle energy purchase.

In some embodiments of the payment processing network, the fleet-based merchant discount is calculated according to a fleet-based merchant discount plan.

In some embodiments of the payment processing network, the fleet-based merchant discount plan is registered with the payment processing network prior to being utilized to calculate the fleet-based merchant discount.

In some embodiments of the payment processing network, the advice message is received at the payment processing network from an acquirer for purposes of applying the fleet-based merchant discount.

1. A computer-implemented method, comprising:
receiving, at a fleet-based merchant discount portal of a payment processing network, an advice message from an acquirer, the advice message being associated with a fleet-based vehicle energy purchase initiated at an access device of a merchant;
performing, at the fleet-based merchant discount portal, a fleet-based merchant discount qualification assessment of the advice message to determine whether to apply a fleet-based merchant discount to the fleet-based vehicle energy purchase; and
in response to the fleet-based merchant discount qualification assessment yielding that the fleet-based merchant discount is warranted, generating, at the fleet-based merchant discount portal, a fleet-based merchant discount advice message, and generating a restored fleet-based merchant discount advice response message, wherein the fleet-based merchant discount portal is configured to restore a fleet-based merchant discount advice response message to the restored fleet-based merchant discount advice response message and the fleet-based merchant discount advice message is configured to execute the fleet-based merchant discount on the fleet-based vehicle energy purchase, the fleet-based merchant discount advice message being generated by adding fleet-based merchant discount fields to the advice message to discount the fleet-based vehicle energy purchase.

2. (canceled)

3. The computer-implemented method of claim 1, further comprising:
transmitting the restored fleet-based merchant discount advice response message to the acquirer for use in clearing the fleet-based vehicle energy purchase.

4. The computer-implemented method of claim 3, wherein:
when the fleet-based merchant discount qualification assessment yields that the fleet-based merchant discount is not warranted, the fleet-based merchant discount is not applied to the fleet-based vehicle energy purchase.

5. The computer-implemented method of claim 4, wherein:
the fleet-based vehicle energy purchase is discounted according to a fleet-based merchant discount plan.

6. The computer-implemented method of claim 5, wherein:
the fleet-based merchant discount plan is registered with a fleet-based merchant discount program at the payment processing network prior to applying the fleet-based merchant discount.

7. The computer-implemented method of claim 6, wherein:
the fleet-based vehicle energy purchase is at least one of a fuel purchase and an electricity purchase.

8. The computer-implemented method of claim 1, wherein:
the fleet-based merchant discount qualification assessment includes confirming that an issuer and the acquirer have registered to participate in a fleet-based merchant discount program associated with the fleet-based merchant discount.

9. A system, comprising:
a processor; and
a non-transitory computer readable medium coupled to the processor, the non-transitory computer readable medium including code that:
receives an advice message from an acquirer, the advice message being associated with a fleet-based vehicle energy purchase by a vehicle driver of a fleet vehicle;
performs a fleet-based merchant discount qualification assessment of the advice message to determine whether to apply a fleet-based merchant discount to the fleet-based vehicle energy purchase;
generates a fleet-based merchant discount advice message and a restored fleet-based merchant discount advice response message, wherein a fleet-based merchant discount advice response message is restored to the restored fleet-based merchant discount advice response message and the fleet-based merchant discount advice message is configured to execute the fleet-based merchant discount on the fleet-based vehicle energy purchase, the fleet-based merchant discount advice message being generated by adding fleet-based merchant discount fields to the advice message to discount the fleet-based vehicle energy purchase.

10. (canceled)

11. The system of claim 9, wherein:
transmits the restored fleet-based merchant discount advice response message to the acquirer for use in clearing the fleet-based vehicle energy purchase.

12. The system of claim 11, wherein:
when the fleet-based merchant discount qualification assessment yields that the fleet-based merchant discount is not warranted, the fleet-based merchant discount is not applied to the fleet-based vehicle energy purchase.

13. The system of claim 12, wherein:
the fleet-based vehicle energy purchase is discounted according to a fleet-based merchant discount plan.

14. The system of claim 13, wherein:
the fleet-based merchant discount plan is registered at the system prior to applying the fleet-based merchant discount.

15. The system of claim 14, wherein:
the fleet-based vehicle energy purchase is at least one of a fuel purchase and an electricity purchase.

16. The system of claim 15, wherein:
the fleet-based merchant discount qualification assessment includes confirming that an issuer and the acquirer have registered to participate in a fleet-based merchant discount program associated with the fleet-based merchant discount.

17. A payment processing network, comprising:
a fleet-based merchant discount qualification unit; and
a fleet-based merchant discount calculation and application unit, wherein, based upon a fleet-based merchant discount qualification assessment by the fleet-based merchant discount qualification unit of an advice message received at the payment processing network, the fleet-based merchant discount calculation and application unit utilizes the advice message to calculate a fleet-based merchant discount of a fleet-based vehicle energy purchase, the advice message being updated to include fleet-based merchant discount fields to discount the fleet-based vehicle energy purchase and wherein a fleet-based merchant discount advice message and a restored fleet-based merchant discount advice response message is generated by the payment processing network, a fleet-based merchant discount advice response message being restored to generate the restored fleet-based merchant discount advice response message and the fleet-based merchant discount advice message is configured to execute the fleet-based merchant discount on the fleet-based vehicle energy purchase.

18. The payment processing network of claim 17, wherein:
the fleet-based merchant discount is calculated according to a fleet-based merchant discount plan.

19. The payment processing network of claim 18, wherein:
the fleet-based merchant discount plan is registered with the payment processing network prior to being utilized to calculate the fleet-based merchant discount.

20. The payment processing network of claim 19, wherein:
the advice message is received at the payment processing network from an acquirer for purposes of applying the fleet-based merchant discount.
